(19) United States
(12) Patent Application Publication
(10) Pub. No.: US 2002/0134867 A1
(43) Pub. Date: Sep. 26, 2002

(54) Sprinkler structure

(76) Inventor: Elvis Hsieh, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/798,970

(22) Filed: Mar. 6, 2001

(51) Int. Cl. B05B 15/08

(52) U.S. Cl. 239/588; 239/587.3

(57) ABSTRACT

A sprinkler structure including a flexible tube made of a circular wire material and a differential wire material by spiral winding. The circular wire material and the differential wire material have different winding radiuses, whereby the flexible tube can be bent and patterned. An inner tube is fitted in the flexible tube. Two ends of the inner tube respectively have two stop flanges. Two ends of the flexible tubes are connected with two connectors and the stop flanges of the inner tube extend out of the flexible tube to respectively lean on shoulder sections of the connectors. When the two connectors are connected with a faucet and a sprinkling head, the stop flanges are compressed to achieve a leakproof effect.

### BACKGROUND OF THE INVENTION

The present invention is related to an improved sprinkler structure, and more particularly to a leakproof sprinkler structure in which the flexible tube can be bent and patterned.

FIG. 8 shows a conventional sprinkler having a connector 81 which is formed with an inner thread 811 screwed on outer thread 91 of a faucet 9. The connector 81 is also formed with a hole 812 for connecting with a flexible tube 82. A shoulder section 813 is defined between the hole 812 and the inner thread 811. A washer 84 is disposed on the shoulder section 813. An inner tube 83 is fitted in the flexible tube 82. The inner tube 83 is fitted into the inner hole 841 of the washer 84. After the connector 81 is tightly screwed onto the outer thread 91 of the faucet 9, the washer 84 is inward pressed against the inner tube 83 to achieve a leakproof effect. The other end of the flexible tube 82 is fitted with a sleeve 85 having an outer thread 851 for screwing with a sprinkling head 86. Another washer 84 is disposed between the sleeve 85 and the sprinkling head 86. The inner tube 83 is also fitted in the washer 84 to achieve a leakproof effect. The flexible tube 82 is composed of two metal coils 821, 822 respectively having C-shaped and reverse C-shaped cross-sections. The two metal coils 821, 822 are spirally wound to form the flexible tube 82. When the flexible tube 82 is bent, the two metal coils 821, 822 will partially overlap each other. However, the inner tube 83 is made of soft elastic material so that after bent, the flexible tube 82 will be restored by the elastic inner tube 83. Therefore, the discharging angle of the sprinkling head 86 can be hardly changed by means of bending the flexible tube 82.

Moreover, the inner tube 83 is fitted in the inner holes 841 of the two washers 84 and the washers 84 are compressed and deformed to achieve a leakproof effect. In the case that the water flows out of the faucet 9 at greater pressure, the water often leaks from the minor gaps between the inner tube 83 and the wall of the inner hole 841. After the water infiltrates into the space between the inner tube 83 and the flexible tube 82, the water will further leak from the gaps between the metal coils 821, 822. Therefore, some of the water will remain in the flexible tube 82 to result in problems of rusting and corrosion.

### SUMMARY OF THE INVENTION

It is therefore a primary object of the present invention to provide an improved sprinkler structure including a flexible tube made of a circular wire material and a differential wire material by spiral winding. The circular wire material and the differential wire material have different winding radiuses, whereby after the flexible tube is bent, the two kinds of wire materials have different curvatures and engage with each other to have a fixed form. Therefore, by means of bending the flexible tube, the discharging direction of the water can be changed. An inner tube is fitted in the flexible tube. Two ends of the inner tube respectively have two stop flanges. Two ends of the flexible tubes are connected with two connectors. When the two connectors are connected with a faucet and a sprinkling head, the stop flanges are compressed to achieve a leakproof effect.

The present invention can be best understood through the following description and accompanying drawings wherein:

### BRIEF DESCRIPTION OF THE DRAWINGS

FIG. 1 is a perspective assembled view of the present invention;

FIG. 2 is a sectional view taken along line 11-11 of FIG. 1;

FIG. 3 shows that the flexible tube of the present invention is bent to change the discharging direction;

FIG. 4 is an enlarged sectional view of the flexible tube of the present invention in a bent state;

FIG. 5 is a sectional view of a second embodiment of the present invention;

FIG. 6 is a perspective view of a third embodiment of the present invention;

FIG. 7 is a side view of a fourth embodiment of the present invention; and

FIG. 8 is a sectional view of a conventional sprinkler.

### DETAILED DESCRIPTION OF THE PREFERRED EMBODIMENTS

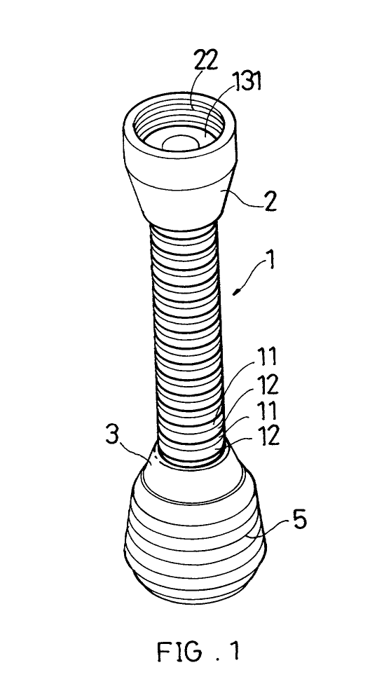

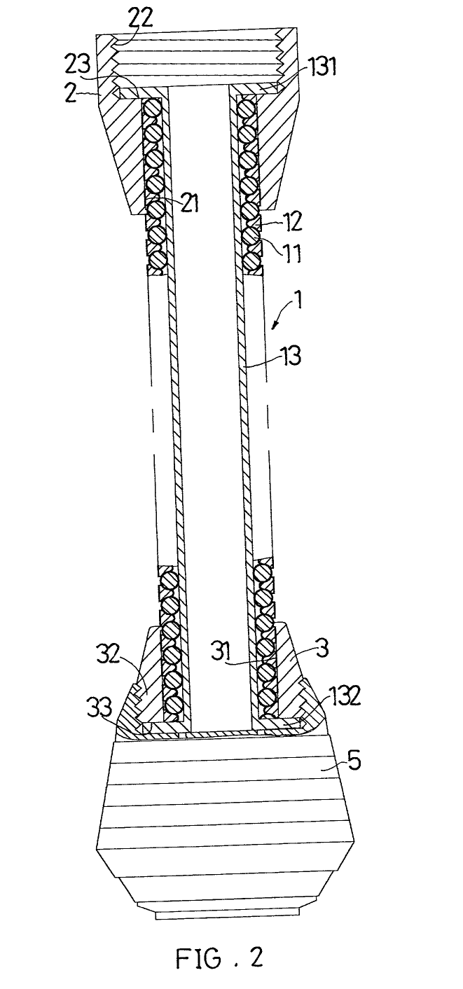

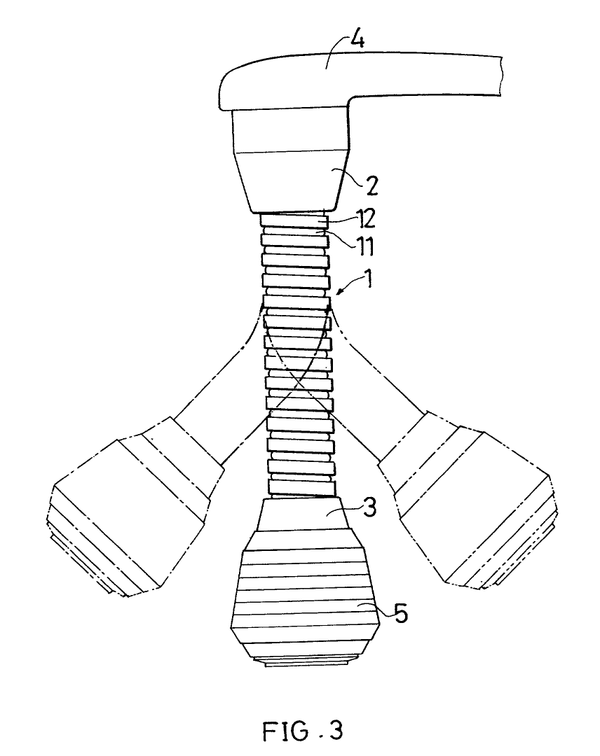

Please refer to FIGS. 1 to 3. The sprinkler structure of the present invention includes:

a flexible tube 1 made of a circular wire material 11 and a differential wire material 12 by spiral winding, the circular wire material 11 and the differential wire material 12 having different winding radiuses and complementary shapes, whereby the flexible tube 1 can be bent and patterned;

an inner tube 13 fitted in the flexible tube 1 and made of soft material, two ends of the inner tube 13 extending out of the flexible tube 1 and respectively integrally having two stop flanges 131, 132;

a first connector 2 connected with the flexible tube 1, the first connector 2 having a first hole 21 in which the flexible tube 1 is inserted, one end of the first hole 21 distal from the flexible tube 1 being formed with an inner thread 22 for screwing with a faucet 4, a first shoulder section 23 being defined between the inner thread 22 and the first hole 21, the stop flange 131 of the inner tube 13 extending out of the flexible tube 1 to lean on the first shoulder section 23, whereby when the first connector 2 is connected with the faucet 4, the faucet 4 presses the stop flange 131 to achieve a leakproof effect; and

a second connector 3 connected with one end of the flexible tube 1 opposite to the first connector 2, the second connector 3 having a second hole 31 in which the flexible tube 1 is inserted, one end of the second connector 3 distal from the flexible tube 1 being formed with an outer thread 32 for screwing with a sprinkling head 5, a second shoulder section 33 being defined between the outer thread 32 and the second hole 31, the other stop flange 132 of the inner tube 13 extending out of the flexible tube 1 to lean on the second shoulder section 33, whereby when the second connector 3 is connected with the sprinkling head 5, the sprinkling head 5 presses the stop flange 132 to achieve a leakproof effect.

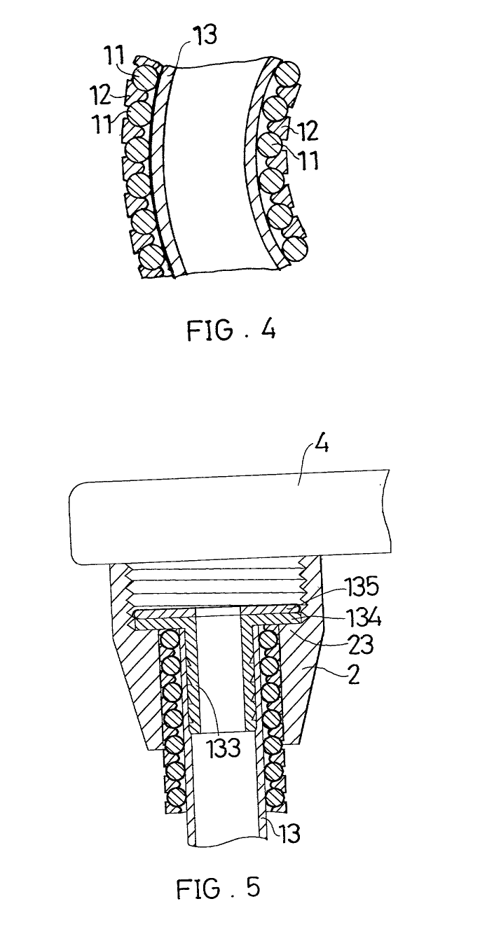

The flexible tube 1 is made of the circular wire material 11 and the differential wire material 12 by spiral winding. The circular wire material 11 and the differential wire material 12 have different winding radiuses as shown in FIG. 4. Therefore, after the flexible tube 1 is bent, the two kinds of wire materials have different curvatures. In addition, the circular wire material 11 and the differential wire material 12 have complementary shapes so that after bent, the circular wire material 11 and the differential wire material 12 will squeeze and engage with each other to have a fixed form. Accordingly, by means of bending the flexible tube 1, the discharging direction of the sprinkling head 5 can be changed. Furthermore, the inner tube 13 is made of soft material so that the stop flanges 131, 132 at two ends of the inner tube 13 can be twisted and compressed. Accordingly, after the inner tube 13 is fitted into the flexible tube 1 with the two stop flanges 131, 132 respectively leant on the first and second shoulder sections 23, 33 of the first and second connectors 2, 3, when the first and second connectors 2, 3 are respectively connected with the faucet 4 and the sprinkling head 5, the faucet 4 and the sprinkling head 5 can compress the two stop flanges 131, 132 to achieve leakproof effects.

FIG. 5 shows a second embodiment of the present invention, in which a metal hub 133 is fitted inside the inner tube 13. The hub 133 has an outer diameter slightly larger than the inner diameter of the inner tube 13. When the hub 133 is fitted in the inner tube 13, the inner tube 13 is compressed and tightly retained between the flexible tube 1 and the hub 133. The hub 133 has an integrally extending flange 134 for leaning on the first shoulder section 23 as the stop flange 131. A washer 135 is positioned between the flange 134 and the faucet 4 to achieve the same leakproof effect as the first embodiment.

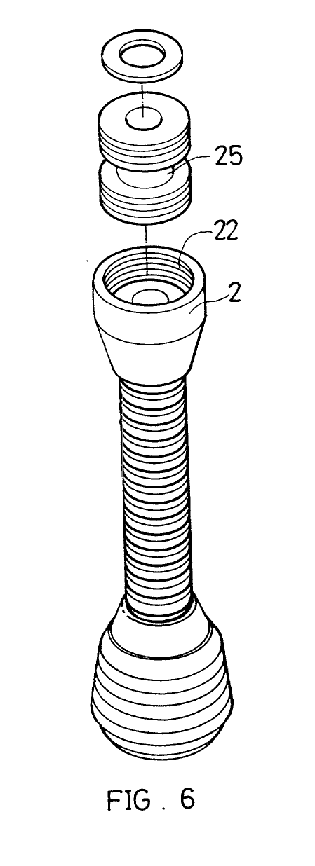

FIG. 6 shows a third embodiment of the present invention, in which the inner thread 22 of the first connector 2 is screwed with a connector 25 with double layers of threads. Via the connector 25, the first connector 2 is adaptable to different types of faucets.

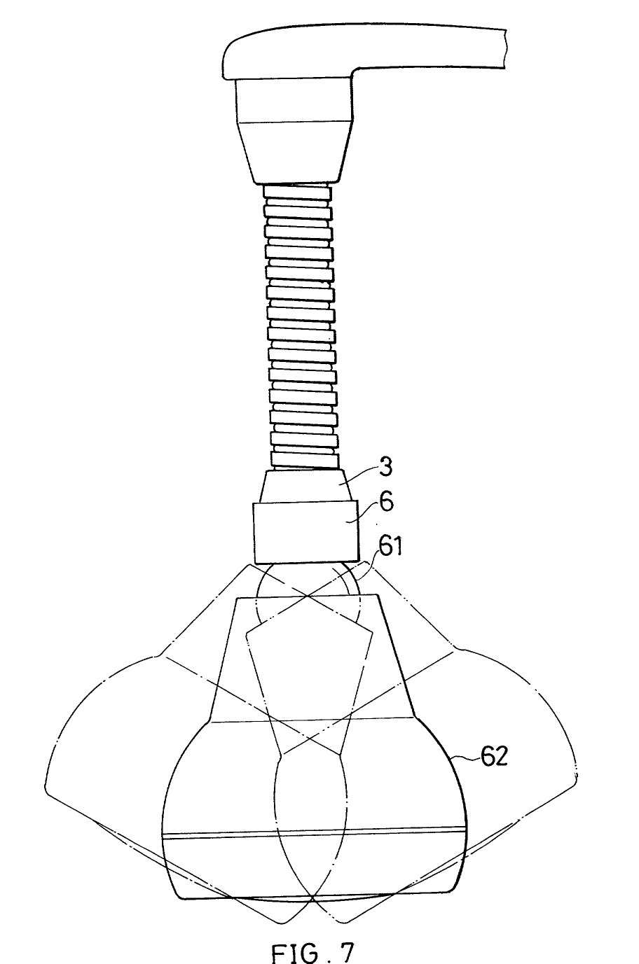

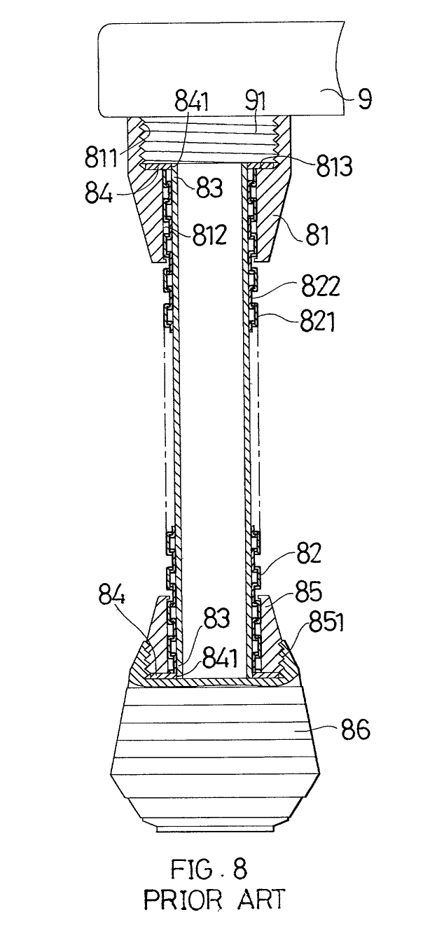

FIG. 7 shows a fourth embodiment of the present invention, in which the sprinkling head 5 is replaced by another type of sprinkling head 6. In this embodiment, the sprinkling head 6 has a ball joint 61 for connecting with a discharge head 62. With the flexible tube 1 not bent, the discharge head 62 can be turned to change the discharging direction of the sprinkling head 6.

The above embodiments are only used to illustrate the present invention, not intended to limit the scope thereof. Many modifications of the above embodiments can be made without departing from the spirit of the present invention.

What is claimed is:

1. A sprinkler structure comprising:
a flexible tube made of a circular wire material and a differential wire material by spiral winding, the circular wire material and the differential wire material having different winding radiuses and complementary shapes, whereby the flexible tube can be bent and patterned;
an inner tube fitted in the flexible tube and made of soft material, two ends of the inner tube extending out of the flexible tube and respectively integrally having two stop flanges; and
two connectors connected with two ends of the flexible tube, the two connectors respectively having thread sections for screwing with a faucet and a sprinkling head, a shoulder section being formed at one end of each thread section proximal to the faucet and sprinkling head, the stop flanges of the inner tube being respectively leant on the shoulder sections, whereby when the two connectors are connected with the faucet and sprinkling head, the faucet and sprinkling head press the stop flanges to achieve a leakproof effect.

2. A sprinkler structure as claimed in claim 1, wherein the two connectors are:
a first connector connected with the flexible tube, the first connector having a first hole in which the flexible tube is inserted, one end of the first hole distal from the flexible tube being formed with an inner thread for screwing with a faucet, a first shoulder section being defined between the inner thread and the first hole, one of the stop flanges of the inner tube extending out of the flexible tube to lean on the first shoulder section, whereby when the first connector is connected with the faucet, the faucet presses the stop flange to achieve a leakproof effect; and
a second connector connected with one end of the flexible tube opposite to the first connector, the second connector having a second hole in which the flexible tube is inserted, one end of the second connector distal from the flexible tube being formed with an outer thread for screwing with a sprinkling head, a second shoulder section being defined between the outer thread and the second hole, the other stop flange of the inner tube extending out of the flexible tube to lean on the second shoulder section, whereby when the second connector is connected with the sprinkling head, the sprinkling head presses the stop flange to achieve a leakproof effect.

3. A sprinkler structure as claimed in claim 1, wherein a metal hub is fitted in one end of the inner tube, the hub having an outer diameter slightly larger than the inner diameter of the inner tube, whereby when the inner tube is compressed and tightly retained between the flexible tube and the hub, one end of the hub distal from the inner tube having a flange for leaning on the shoulder section of the connector.
